(19) United States
(12) Patent Application Publication
(10) Pub. No.: US 2009/0274316 A1
(43) Pub. Date: Nov. 5, 2009

(54) SYSTEM AND METHOD FOR COUNTERING NOISE WHEN OPERATING AN ADDRESS SYSTEM IN A PASSENGER TRANSPORT

(75) Inventor: George Van Tran, Bothell, WA (US)

Correspondence Address: LAW OFFICE OF DONALD D. MONDUL, 3060 BONSAI DRIVE, PLANO, TX, 75093, US

(73) Assignee: BOEING COMPANY, A CORPORATION OF DELAWARE, Chicago, IL (US)

(21) Appl. No.: 12/114,142

(22) Filed: May 2, 2008

(51) Int. Cl. G10K 11/16

(52) U.S. Cl. 381/71.4; 381/83

(57) ABSTRACT

A system for countering ambient noise when operating an address system in at least one compartment of a passenger transport unit includes: (a) a noise control unit; and (b) at least one memory unit coupled with the noise control unit. The at least one memory unit stores noise characteristic information relating with at least one operational condition of the transport unit. The noise control unit employs the noise characteristic information to effect the countering.

### FIELD

The present disclosure is directed to noise countering systems and methods, and especially to noise countering systems and methods for use with passenger transport units such as, by way of example and not by way of limitation, a passenger aircraft.

### BACKGROUND

The following description may relate to a passenger aircraft, but the disclosure may be applicable to other passenger transport units with equal success. Noise levels in a passenger transport unit such as, by way of example and not by way of limitation, a passenger aircraft may vary significantly depending upon the operation in which the passenger transport is engaged. For example, an aircraft may present different levels of noise in a passenger compartment when the aircraft is engaged in an activity on the ground such as, by way of example and not by way of limitation, taxiing, taking off or landing.

Noise levels in a passenger aircraft may vary significantly when the aircraft is engaged in different activities aloft. By way of example and not by way of limitation, noise levels in a passenger compartment may vary when the aircraft is engaged in an activity aloft such as, by way of example and not by way of limitation, climbing, descending, turning or flying level.

Today's passenger transport units, such as passenger airplanes, may include a plurality of passenger compartments, and different passenger compartments may exhibit different noise characteristics during a given flight or ground evolution. By way of further example and not by way of limitation, a lower level passenger compartment may experience a greater noise level during ground taxiing than may be experienced in a compartment further removed from the ground.

Manual control of volume of an address system to accommodate various noise levels while using the address system may be difficult. Delivery of information via voice may actually be impaired by a user inexpertly adjusting output volume of the address system to counter noise while passengers are addressed.

There is a need for a system and method for countering noise when operating an address system in a passenger transport.

### SUMMARY OF THE INVENTION

A system for countering ambient noise when operating an address system in at least one compartment of a passenger transport unit includes: (a) a noise control unit; and (b) at least one memory unit coupled with the noise control unit. The at least one memory unit stores noise characteristic information relating with at least one operational condition of the transport unit. The noise control unit employs the noise characteristic information to effect the countering.

The at least one memory unit may be at least one non-volatile memory unit. The at least one memory unit may store at least one noise profile data base containing information relating to operation of the passenger transport unit such as, by way of example and not by way of limitation, airplane compartment noise levels during different modes of operation. Modes of operation may include, by way of example and not by way of limitation, altitude expressed in feet, airspeed expressed as a Mach number, a WOW (Weight on Wheels) indicator relating to whether the passenger transport unit is on ground or aloft, door status indicating open or closed, at least one engine parameter such as RPM or thrust, flap position (up/down or position expressed in degrees), spoiler positions, wind speed (expressed in Miles Per Hour—MPH), ECS (Environmental Control System) status (indicating engagement of air conditioning or heat), APU (Auxiliary Power Unit) parameter (indicating Revolutions Per Minute—RPM), noise frequencies expressed in Hertz (Hz) and noise level expressed in Decibels (Db). Such noise profile data may be collected during flight tests, analyzed and then refined to fit flight patterns of respective aircraft models.

An audio processor may employ the noise profile data base to define ambient noise parameters for each flight mode of an aircraft. At least one communication bus with a backbone communication bus may be employed to obtain information for storing in the noise profile data base, such as noise profile data listed above.

A method for countering ambient noise when operating an address system in at least one compartment of a passenger transport unit includes: (a) in no particular order: (1) providing a noise control unit; and (2) providing at least one memory unit; (b) coupling the at least one memory unit with the noise control unit; (c) operating the at least one memory unit to store noise characteristic information relating with at least one operational condition of the transport unit; and (d) operating the noise control unit employing the noise characteristic information to effect countering.

It is, therefore, a feature of the present disclosure to present a system and method for countering noise when operating an address system in a passenger transport.

Further objects and features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic illustration of a system for countering ambient noise when operating an address system in a compartment of passenger transport unit.

FIG. 2 is a schematic illustration of a system for countering ambient noise when operating an address system in a plurality of compartments in a passenger transport unit.

FIG. 3 is a flow diagram illustrating a method for countering ambient noise when operating an address system in a compartment of passenger transport unit.

FIG. 4 is a block diagram of an aircraft.

### DETAILED DESCRIPTION

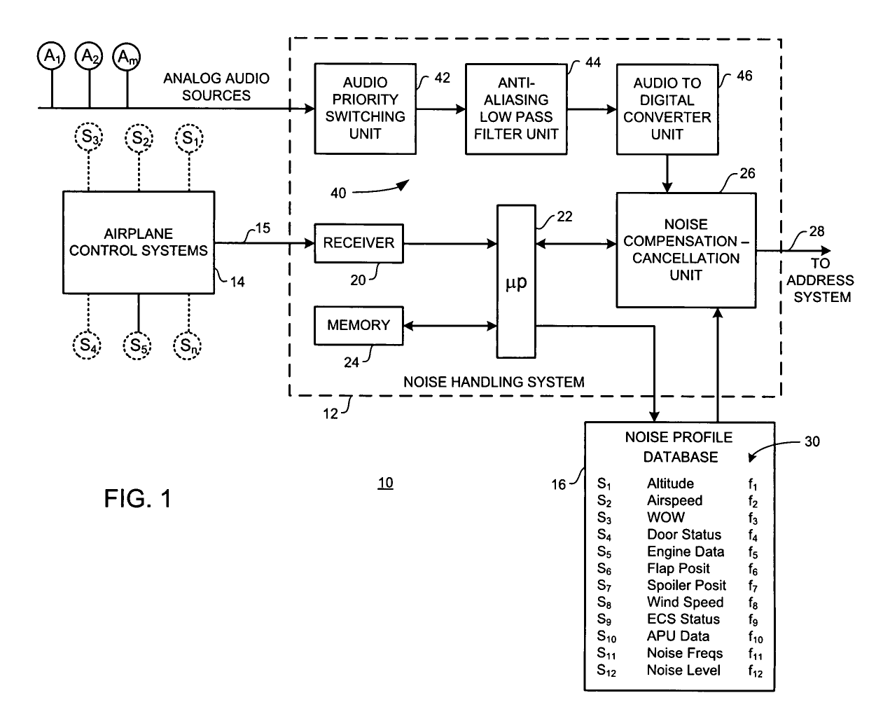

FIG. 1 is a schematic illustration of a system for countering ambient noise when operating an address system in a compartment of passenger transport unit. In FIG. 1, a system 10 for countering noise in a compartment of a passenger transport unit may include a noise handling system 12. Noise handling system 12 may be coupled with a transport control unit such as an airplane control unit 14 via an aircraft communication bus 15 or similar communicating connection.

Airplane control unit 14 may be coupled with a plurality of sensors located in various loci about an airplane for presenting an indication representing operation condition of a transportation unit carrying system 10, such as an airplane. Airplane control unit 14 may be coupled with sensors S₁, S₂, S₃, S₄, S₅, Sₙ. These sensors may be used for the Flight Controls System. The indicator “n” is employed to signify that there can be any number of sensors coupled with airplane control unit 14. The inclusion of six sensors S₁, S₂, S₃, S₄, S₅, Sₙ in FIG. 1 is illustrative only and does not constitute any limitation regarding the number of sensors that may be included in the system of the present disclosure.

Sensors S₁, S₂, S₃, S₄, S₅, Sₙ may be used by airplane control unit 14 for other purposes, and may include by way of example and not by way of limitation, the following indicators:

Altitude (Feet)

Airspeed (Mach)

WOW (Weight on Wheels; indicates whether airplane is on ground or aloft)

Door Status (Open or Closed)

Engine Parameter(s) (RPM or Thrust)

Flap Position (Up or Down; Degrees)

Spoiler Positions

Wind Speed (MPH)

ECS Status (Environmental Control System; AC or Heat)

APU Parameter(s) (Auxiliary Power Unit; RPM)

Noise Frequencies (Hz)

Noise Level (dB)

Each of the sensors may provide information or indications that may be represented in terms of the contribution the sensed indication may make to ambient noise within a compartment of a transport unit, such as an airplane. By way of example and not by way of limitation, different evolutions may present different noise characteristics in a compartment of an aircraft. An airplane may present a first set of noises—in terms of volume levels, frequencies and patterns—while taxiing to a runway in preparation for take off. The same aircraft may present a different second set of noises while taking off. The same aircraft may present a third set of noises while cruising. Characteristics of noises sensed by sensors S₁, S₂, S₃, S₄, S₅, Sₙ may be stored in a memory or storage unit 16. Noise handling system 12 may include a receiver unit 20 coupled with a processing unit, such as by way of example and not by way of limitation, microprocessor unit 22. Microprocessor unit 22 may be coupled with a local memory unit 24 to aid in processing performed by microprocessor unit 22. Memory unit 16 may be coupled with microprocessor unit 22. Memory unit 16 may be coupled with airplane control unit 14 for receiving updates of indications from sensors S₁, S₂, S₃, S₄, S₅, Sₙ. Alternatively, associations between noise affecting factors and respective sensor indications from sensors S₁, S₂, S₃, S₄, S₅, Sₙ, may be predetermined such as, by way of example and not by way of limitation, during one or more test flights or other test operations. The predetermined factors may be stored in memory unit 16 to form a noise profile data base 30. By way of example and not by way of limitation, a sensor S₁ may sense altitude in feet and altitude may be indicated by a factor f₁. A sensor S₂ may sense airspeed as a mach number and airspeed may be indicated by a factor f₂. A sensor S₃ may sense weight on wheels (WOW) as an indication whether the aircraft is operating on the ground or is aloft and WOW may be indicated by a factor f₃. A sensor S₄ may sense status of the aircraft passenger access door as being open or closed and door status may be indicated by a factor f₄. A sensor S₅ may sense engine data such as revolutions per minute (RPM) or pounds of thrust and engine data may be indicated by a factor f₅. A sensor S₆ may sense flap position in terms of whether the flaps are up or down and by how many degrees and flap position may be indicated by a factor f₆. A sensor S₇ may sense spoiler position in terms of whether the spoilers are deployed or not deployed and spoiler position may be indicated by a factor f₇. A sensor S₈ may wind speed in terms of miles per hour (MPH) and MPH may be indicated by a factor f₈. A sensor S₉ may sense status of the aircraft ECS (Environmental Control System) in terms of whether the ECS is heating or cooling the passenger compartment and ECS status may be indicated by a factor f₉. A sensor S₁₀ may sense status of the aircraft APU (Auxiliary Power Unit) in terms of revolutions per minute (RPM) and APU RPM may be indicated by a factor f₁₀. A sensor S₁₁ may sense noise frequencies present in the passenger compartment or elsewhere in or around the aircraft in terms of Hertz (Hz) and noise frequencies may be indicated by a factor f₁₁. A sensor S₁₂ may sense noise levels present in the passenger compartment or elsewhere in or around the aircraft in terms of decibels (dB) and noise levels may be indicated by a factor f₁₂. Microprocessor unit 22 may employ some or all of factors f₁-f₁₂ in a noise compensation—cancellation unit 26 to present an output signal at an output locus 28 for use by an address system (not shown in FIG. 1) to effect countering ambient noise in a compartment of a passenger transport unit, such as a passenger aircraft. Memory unit 16 may be configured integrally within noise handling system 12, or memory unit 16 may be configured as a unit separate from noise handling system 12, as shown in FIG. 1.

Sensors S₁, S₂, S₃, S₄, S₅, Sₙ are indicated in FIG. 1 in dotted line format to represent that sensors S₁, S₂, S₃, S₄, S₅, Sₙ may be employed during flight testing or similar pre-operational evolutions to collect data for creation of noise profile database 30 to store indications relating with airplane compartment noise at levels at different modes of operations such as, by way of example and not by way of limitation, factors f₁-f₁₂. Data for populating noise profile database 30 may be collected during flight tests, analyzed and refined to fit the flight patterns of each respective aircraft model. Noise compensation-cancellation unit 26 may use noise profile database 30 to define ambient noise parameters for each flight mode. Noise cancellation unit 26 may employ factors f₁-f₁₂ to effect noise cancellation using any method known by those skilled in the art of compensating or countering ambient noise.

If system 10 is to be used for countering ambient noise in a plurality of passenger compartments, factors f₁-f₁₂ may vary among respective compartments of the plurality of compartments for each indicator sensed by sensors S₁, S₂, S₃, S₄, S₅, Sₙ as the effect of a particular indicator may differently impact a particular respective compartment.

System 10 may also include a plurality of passenger address audio sources A₁, A₂, Aₘ relating to passenger address units or systems. The indicator “m” is employed to signify that there can be any number of audio sensors included in system 10. The inclusion of three audio sources A₁, A₂, Aₘ in FIG. 1 is illustrative only and does not constitute any limitation regarding the number of audio sensors that may be included in the system of the present disclosure.

Passenger address audio sources A₁, A₂, Aₘ may be coupled with an audio compensating system 40 included within noise handling system 12. Audio compensating system 40 may include an audio priority switching unit 42, an anti-aliasing low pass filter unit 44 and an audio-to-digital converter unit 46. Audio priority switching unit 42 may receive indications of passenger address audio signals from audio sources A₁, A₂, Aₘ and may affect the amount of influence received audio signals may have upon operation of system 10. Audio priority switching unit 42 may be coupled with anti-aliasing low pass filter unit 44 for treating sampling of signals provided from audio priority switching unit 42. Anti-aliasing low pass filter unit 44 may be coupled with audio-to-digital converter unit 46 for converting audio signals received from anti-aliasing low pass filter unit 44 to digital signals for use by noise compensation-cancellation unit 26. Audio compensating system 40 may be configured integrally within noise handling system 12 as shown in FIG. 1, or audio compensating system 40 may be configured as a unit separate from noise handling system 12 (not shown in FIG. 1; understood by one skilled in the art of signal handling circuit design).

Sensors S₁, S₂, S₃, S₄, S₅, Sₙ may be operational sensors associated with providing information to airplane control unit 14. Operating noise compensation-cancellation unit 26 using factors f₁-f₁₂ based upon indicators sensed by sensors S₁, S₂, S₃, S₄, S₅, Sₙ during test flights or other test operations may permit effecting noise compensation-cancellation without having to provide additional real-time sensors. Indications of passenger address audio signals from audio sources A₁, A₂, Aₘ may also be provided without requiring additional sensors. Such audio-related indications may simply represent operational status of an audio source A₁, A₂, Aₘ such as, by way of example and not by way of limitation, “ON”, “OFF” or “TRANSMITTING”. Compensation for audio signals may be based upon predetermined correcting or compensating factors related with such operational statuses. Savings may thus be realized in avoiding additional costs (no additional costs for providing additional sensors) and reduced opportunities for malfunctioning sensors because there may be no additional sensors.

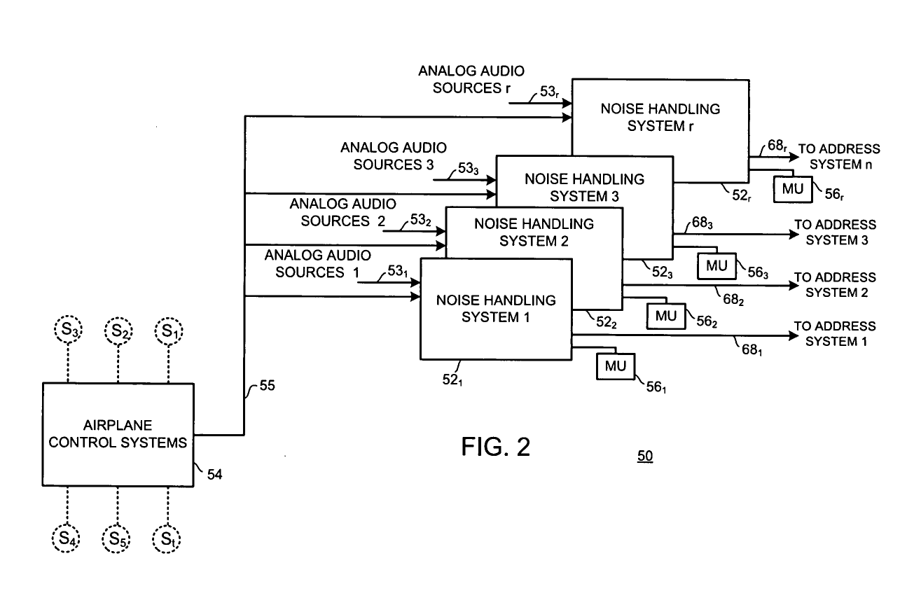

FIG. 2 is a schematic illustration of a system for countering ambient noise when operating an address system in a plurality of compartments in a passenger transport unit. In FIG. 2, a system 50 for countering noise in a plurality of compartments of a passenger transport unit may include noise handling systems 52₁, 52₂, 52₃, 52ᵣ. The indicator “r” is employed to signify that there can be any number of noise handling systems in system 50. The inclusion of four noise handling systems 52₁, 52₂, 52₃, 52ᵣ in FIG. 2 is illustrative only and does not constitute any limitation regarding the number of noise handling systems that may be included in the system of the present disclosure. Noise handling systems 52₁, 52₂, 52₃, 52ᵣ may be coupled with a control unit such as an airplane control unit 54 via an aircraft communication bus 55 or similar communicating connection.

Airplane control unit 54 may be coupled with a plurality of sensors located in various loci about an airplane for presenting an indication representing operation condition of a transportation unit carrying system 50, such as an airplane. Airplane control unit 54 may be coupled with sensors S₁, S₂, S₃, S₄, S₅, Sₜ. The indicator “t” is employed to signify that there can be any number of sensors coupled with airplane control unit 14. The inclusion of six sensors S₁, S₂, S₃, S₄, S₅, Sₜ in FIG. 2 is illustrative only and does not constitute any limitation regarding the number of sensors that may be included in the system of the present disclosure.

Sensors S₁, S₂, S₃, S₄, S₅, Sₜ may be used by airplane control unit 54 for other purposes, and may include by way of example and not by way of limitation, indicators described in connection with sensors Sₙ in FIG. 1.

Each of the sensors S₁, S₂, S₃, S₄, S₅, Sₜ may provide information or indications that may be represented in terms of the contribution the sensed indication may make to ambient noise within a compartment of a transport unit, such as an airplane. By way of example and not by way of limitation, different evolutions may present different noise characteristics in a compartment of an aircraft. An airplane may present a first set of noises—in terms of volume levels, frequencies and patterns—while taxiing to a runway in preparation for take off. The same aircraft may present a different second set of noises while taking off. The same aircraft may present a third set of noises while cruising. Characteristics of noises sensed by sensors S₁, S₂, S₃, S₄, S₅, Sₜ may be stored in a respective memory or storage unit 56₁, 56₂, 56₃, 56ᵣ.

Each noise handling system 52ᵣ may include a receiver unit, a microprocessor unit, a local memory unit and a noise compensation-cancellation unit generally as described in connection with system 10 (FIG. 1). Associations between noise affecting factors and respective sensor indications from sensors S₁, S₂, S₃, S₄, S₅, Sₜ, may be predetermined and the predetermined factors may be stored in a respective memory unit 56₁, 56₂, 56₃, 56ᵣ. Each respective memory unit 56₁, 56₂, 56₃, 56ᵣ may be formed integrally with a respective noise handling system 52₁, 52₂, 52₃, 52ᵣ or may be coupled with a respective noise handling system 52₁, 52₂, 52₃, 52ᵣ. Each respective memory unit 56₁, 56₂, 56₃, 56ᵣ may store a respective predetermined noise profile data base (see noise profile data base 30; FIG. 1) for a respective passenger compartment.

Sensors S₁, S₂, S₃, S₄, S₅, Sₜ are indicated in FIG. 2 in dotted line format to represent that sensors S₁, S₂, S₃, S₄, S₅, Sₜ may be employed during flight testing or similar pre-operational evolutions to collect data for creation of a respective noise profile database in each respective memory unit 56₁, 56₂, 56₃, 56ᵣ to store indications relating with airplane compartment noise at levels at different modes of operations such as, by way of example and not by way of limitation, factors f₁-f₁₂ (FIG. 1). Data for populating each respective noise profile database in each respective memory unit 56₁, 56₂, 56₃, 56ᵣ may be collected during flight tests, analyzed and refined to fit the flight patterns of each respective aircraft model. Each respective noise handling system 52₁, 52₂, 52₃, 52ᵣ may use a respective noise profile database in a respective memory unit 56₁, 56₂, 56₃, 56ᵣ to define ambient noise parameters for each flight mode.

Microprocessor units in each noise handling system 52ᵣ may employ some or all of the respective factors f₁-f₁₂ stored in an associated memory unit in a respective noise compensation—cancellation unit (not shown in FIG. 2) to present an output signal at a respective output locus 68ᵣ for use by an address system (not shown in FIG. 2) to effect countering ambient noise in a respective compartment of a passenger transport unit, such as a passenger aircraft.

Factors f₁-f₁₂ may vary among respective memory units 56₁, 56₂, 56₃, 56ᵣ to provide a respective predetermined noise profile data base (see noise profile data base 30; FIG. 1) for each respective passenger compartment in a passenger transport unit.

System 50 may also include a plurality of-passenger address audio source signals relating to passenger address units or systems provided to audio input loci 53₁, 53₂, 53₃, 53ᵣ of noise handling systems 53₁, 53₂, 53₃, 53ᵣ. Audio source signals may be processed by an audio compensating system included within each respective noise handling system 52ᵣ (see audio compensating system 40; FIG. 1) and provided for use by a respective noise compensation-cancellation unit (see noise compensation-cancellation unit 26; FIG. 1) in a respective noise handling system 52ᵣ.

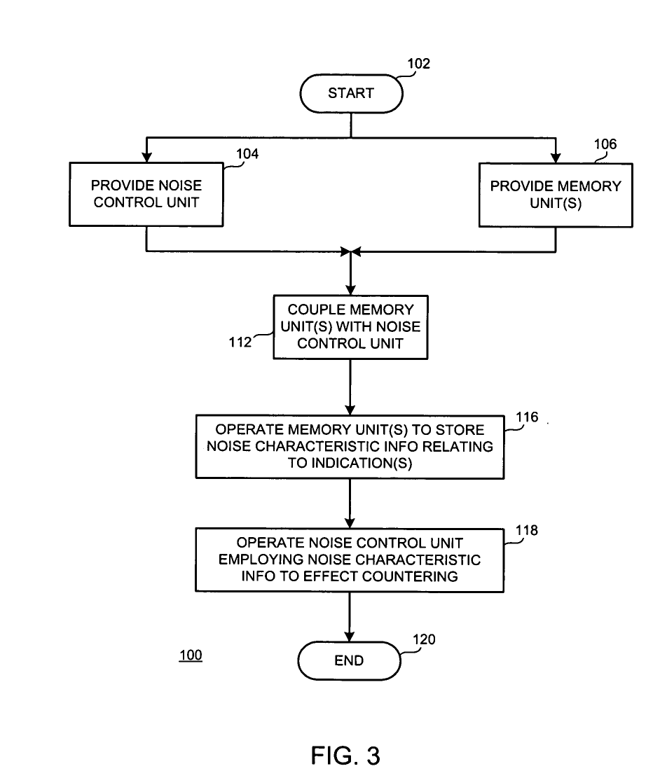

FIG. 3 is a flow diagram illustrating a method for countering ambient noise when operating an address system in a compartment of passenger transport unit. In FIG. 3, a method 100 for countering ambient noise when operating an address system in at least one compartment of a passenger transport unit may begin at a START locus 102.

Method 100 may continue with, in no particular order: (1) providing a noise control unit, as indicated by a block 104; and (2) providing at least one memory unit, as indicated by a block 106.

Method 100 may continue with, coupling the at least one memory unit with the noise control unit, as indicated by a block 1 12.

Method 100 may continue with operating the at least one memory unit to store noise characteristic information relating with at least one selected indication of the at least one indication, as indicated by a block 1 16.

Method 100 may continue with operating the noise control unit employing the noise characteristic information to effect the countering, as indicated by a block 1 18. Method 100 may terminate at an END locus 120.

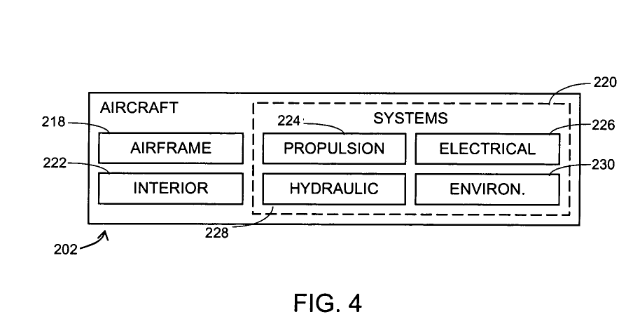

FIG. 4 is a block diagram of an aircraft. In FIG. 4, an aircraft 202 may include an airframe 218 with a plurality of systems 220 and an interior 222. Examples of high-level systems 220 include one or more of a propulsion system 224, an electrical system 226, a hydraulic system 228, and an environmental system 230. Any number of other systems may be included. Although an aerospace example is shown, the principles of the invention may be applied to other industries, such as the automotive industry.

It is to be understood that, while the detailed drawings and specific examples given describe preferred embodiments of the disclosure, they are for the purpose of illustration only, that the system and method of the disclosure are not limited to the precise details and conditions disclosed and that various changes may be made therein without departing from the spirit of the disclosure which is defined by the following claims:

I claim:

1. A system for countering ambient noise when operating an address system in at least one compartment of a passenger transport unit; the system comprising:
(a) a noise control unit; and
(b) at least one memory unit coupled with said noise control unit; said at least one memory unit storing noise characteristic information relating with at least one operational condition of said transport unit;
said noise control unit employing said noise characteristic information to effect said countering.

2. A system for countering ambient noise when operating an address system in at least one compartment of a passenger transport unit as recited in claim 1 wherein the system further comprises at least one audio sensor; said at least one audio sensor being situated at at least one locus of said passenger transport unit; said at least one audio sensor being coupled with said noise control unit for providing audio information relating to said at least one locus; said noise control unit also employing said audio information to effect said countering.

3. A system for countering ambient noise when operating an address system in at least one compartment of a passenger transport unit as recited in claim 1 wherein said at least one compartment is a plurality of compartments; said at least one memory unit storing said noise characteristic information relating with each respective compartment of said plurality of compartments; said countering varying for each respective compartment according to said noise characteristic information relating with said respective compartment.

4. A system for countering ambient noise when operating an address system in at least one compartment of a passenger transport unit as recited in claim 1 wherein said at least one memory unit is coupled with a transport control unit; said transport control unit controlling predetermined operations of said passenger transport unit.

5. A system for countering ambient noise when operating an address system in at least one compartment of a passenger transport unit as recited in claim 4 wherein said transport unit is a passenger aircraft, and wherein said transport control unit is an aircraft control unit.

6. A system for countering ambient noise when operating an address system in at least one compartment of a passenger transport unit as recited in claim 5 wherein the system further comprises at least one audio sensor; said at least one audio sensor being situated at at least one locus of said passenger transport unit; said at least one audio sensor being coupled with said noise control unit for providing audio information relating to said at least one locus; said noise control unit also employing said audio information to effect said countering.

7. A system for countering ambient noise when operating an address system in at least one compartment of a passenger transport unit as recited in claim 6 wherein said at least one compartment is a plurality of compartments; said at least one memory unit storing said noise characteristic information relating with each respective compartment of said plurality of compartments; said countering varying for each respective compartment according to said noise characteristic information relating with said respective compartment.

8. A system for countering ambient noise when operating an address system in a plurality of compartments of a passenger transport unit; the system comprising:
(a) a noise control unit; and
(b) at least one memory unit coupled with said noise control unit; said at least one memory unit storing noise characteristic information relating with at least one operational condition of said transport unit;
said noise control unit employing said noise characteristic information to effect said countering in each respective compartment of said plurality of compartments.

9. A system for countering ambient noise when operating an address system in a plurality of compartments of a passenger transport unit as recited in claim 8 wherein the system further comprises a plurality of audio sensors situated at plurality of loci of said passenger transport unit; said plurality of audio sensors being coupled with said noise control unit for providing audio information relating to said plurality of loci; said noise control unit also employing said audio information to effect said countering.

10. A system for countering ambient noise when operating an address system in a plurality of compartments of a passenger transport unit as recited in claim 8 wherein said at least one memory unit stores said noise characteristic information relating with each said respective compartment; said countering varying for each said respective compartment according to said noise characteristic information relating with said respective compartment.

11. A system for countering ambient noise when operating an address system in a plurality of compartments of a passenger transport unit as recited in claim 8 wherein said plurality of sensors includes at least one memory unit is coupled with a transport control unit; said transport control unit controlling predetermined operations of said passenger transport unit.

12. A system for countering ambient noise when operating an address system in a plurality of compartments of a passenger transport unit as recited in claim 11 wherein said transport unit is a passenger aircraft, and wherein said transport control unit is an aircraft control unit.

13. A system for countering ambient noise when operating an address system in a plurality of compartments of a passenger transport unit as recited in claim 12 wherein the system further comprises a plurality of audio sensors situated at plurality of loci of said passenger transport unit; said plurality of audio sensors being coupled with said noise control unit for providing audio information relating to said plurality of loci; said noise control unit also employing said audio information to effect said countering.

14. A system for countering ambient noise when operating an address system in a plurality of compartments of a passenger transport unit as recited in claim 3 wherein said at least one memory unit stores said noise characteristic information relating with each said respective compartment; said countering varying for each said respective compartment according to said noise characteristic information relating with said respective compartment.

15. A method for countering ambient noise when operating an address system in at least one compartment of a passenger transport unit; the method comprising:
(a) in no particular order:
(1) providing a noise control unit; and
(2) providing at least one memory unit;
(b) coupling said at least one memory unit with said noise control unit;
(c) operating said at least one memory unit to store noise characteristic information relating with at least one operational condition of said transport unit; and
(d) operating said noise control unit employing said noise characteristic information to effect said countering.

16. A method for countering ambient noise when operating an address system in at least one compartment of a passenger transport unit as recited in claim 15 wherein the method further comprises: providing at least one audio sensor; said at least one audio sensor being situated at at least one locus of said passenger transport unit; said at least one audio sensor being coupled with said noise control unit for providing audio information relating to said at least one locus; said noise control unit also employing said audio information to effect said countering.

17. A method for countering ambient noise when operating an address system in at least one compartment of a passenger transport unit as recited in claim 15 wherein said at least one compartment is a plurality of compartments; said at least one memory unit storing said noise characteristic information relating with each respective compartment of said plurality of compartments; said countering varying for each respective compartment according to said noise characteristic information relating with said respective compartment.

18. A method for countering ambient noise when operating an address system in at least one compartment of a passenger transport unit as recited in claim 15 wherein said at least one memory unit is coupled with a transport control unit; said transport control unit controlling predetermined operations of said passenger transport unit.

19. A method for countering ambient noise when operating an address system in at least one compartment of a passenger transport unit as recited in claim 18 wherein said transport unit is a passenger aircraft, and wherein said transport control unit is an aircraft control unit.

20. A method for countering ambient noise when operating an address system in at least one compartment of a passenger transport unit as recited in claim 5 wherein the method further comprises: providing at least one audio sensor; said at least one audio sensor being situated at at least one locus of said passenger transport unit; said at least one audio sensor being coupled with said noise control unit for providing audio information relating to said at least one locus; said noise control unit also employing said audio information to effect said countering; and wherein said at least one compartment is a plurality of compartments; said at least one memory unit storing said noise characteristic information relating with each respective compartment of said plurality of compartments; said countering varying for each respective compartment according to said noise characteristic information relating with said respective compartment.

21. A system for countering ambient noise when operating a public address system in a passenger aircraft; the system comprising:
(a) a noise control unit;
(b) at least one memory unit coupled with said noise control unit; said at least one memory unit storing noise characteristic information relating with at least one operational condition of said passenger aircraft; said noise control unit employing said noise characteristic information to effect said countering; said at least one memory unit being coupled with an aircraft control unit; said aircraft control unit controlling predetermined operations of said passenger aircraft; and
(c) at least one audio sensor; said at least one audio sensor being situated at at least one locus of said passenger aircraft; said at least one audio sensor being coupled with said noise control unit for providing audio information relating to said at least one locus; said noise control unit also employing said audio information to effect said countering.

22. A method for countering ambient noise when operating a public address system in a passenger aircraft; the method comprising:
(a) in no particular order:
(1) providing a noise control unit;
(2) providing at least one memory unit; and
(3) providing at least one audio sensor; said at least one audio sensor being situated at at least one locus of said passenger aircraft;
(b) in no particular order:
(1) coupling said at least one memory unit with said noise control unit; and
(2) coupling said at least one audio sensor with said noise control unit;
(c) in no particular order:
(1) operating said at least one memory unit to store noise characteristic information relating with at least one operational condition of said passenger aircraft; and
(2) operating said at least one audio sensor to provide audio information to said memory unit; said audio information relating to said at least one locus; and
(d) operating said noise control unit employing said noise characteristic information and said audio information to effect said countering.
